(19) United States
(12) Patent Application Publication
(10) Pub. No.: US 2016/0171561 A1
(43) Pub. Date: Jun. 16, 2016

(54) ACCOUNTING FOR FEATURES OF PREVIOUSLY-PRESENTED CONTENT ITEMS WHEN SELECTING CONTENT ITEMS FOR AN ONLINE SYSTEM USER

(71) Applicant: Facebook, Inc., Menlo Park, CA (US)

(72) Inventors: Yi Tang, Mountain View, CA (US); Kai Du, III, San Jose, CA (US); Sourav Chatterji, Fremont, CA (US); Anand Sumatilal Bhalgat, Mountain View, CA (US); Ke Pan, Sunnyvale, CA (US)

(21) Appl. No.: 14/566,693

(22) Filed: Dec. 10, 2014

(51) Int. Cl. G06Q 30/02

(52) U.S. Cl. CPC G06Q 30/0275; G06Q 30/0269

(57) ABSTRACT

An online system penalizes content items having features matching features of additional content items previously presented to a user within a specified time interval. The online system identifies various features of the content item and identifies features of content items previously presented to the user within the specified time interval. Feature penalties are determined for various features of the content item based on a number of previously presented content items having a common feature with the content item. Weights may be associated with various content items having a feature matching a feature of the content item based on a time between presentation of the previously presented content item and a current time. A penalty for the content item is determined based on the feature penalties for the features of the content item, and the penalty is applied to a bid amount associated with the content item.

### BACKGROUND

This disclosure relates generally to presenting content to users of an online system, and more specifically to selecting content items based at least in part on features of content items previously presented to a user.

An online system allows users to connect to and to communicate with other users of the online system. Users create profiles on an online system that are tied to their identities and include information about the users, such as interests and demographic information. The users may be individuals or entities such as corporations or charities. Content items are presented to various users by the online system to encourage users to interact with the online system.

However, as the amount of content provided by the online system increases, users may be presented with an increasing amount of content in which the users have little interest. Additionally, as the online system presents content to a user, the user may be presented with various content items having similar features to content items previously presented to the user. Presenting a user with multiple content items may decrease the likelihood of the user interacting with the content items or even discourage the user from interacting with the online system. For example, presenting multiple content items including content having a common topic, or having similar topics, within a threshold time interval may discourage the user from interacting with content provided by the online system by inundating the user with content relating to the topic.

### SUMMARY

An online system, such as a social networking system, selects content items for presentation to a user. To increase a likelihood of the user interacting with presented content items, the online system accounts for features of content items previously presented to the user when selecting content items for presentation to the user to provide a greater diversity of content items to the user. For example, content items previously presented to the user within the specified time interval from a current time are identified by the online system, which identifies features of the previously presented content items.

Features of a content item describe characteristics of the content item or characteristics of content included in the content item. Example features of a content item include: a user associated with the content item, a description of the content included in the content item (e.g., an image identifier, text in the advertisement, an identifier of video included in the advertisement, an identifier of audio data included in the advertisement), a landing page identified by the content item, and one or more topics associated with the content item. If a content item has previously been presented to the user, a feature may identify a type of display unit in which the content item was presented to the user (e.g., if the content item was included in a display unit including multiple content items, if the content item was presented as an individual content item). Similarly, a feature may identify a type of display unit for use in presenting the content item. Additionally, if a content item is an ad request, a feature may identify an advertising campaign including the ad request.

Based on features of a content item and features of content items previously presented to the user, the online system determines a penalty for the content item. In one embodiment, the online system determines feature penalties associates with various features of the content item. A feature penalty associated with a feature is based on a number of previously presented content items having the feature or having an alternative feature similar to the feature. In some embodiments, the online system determines weights associated with various previously presented content items, with a weight associated with a previously presented content item based on a difference between a current time and a time when the previously presented content item was presented. For example, weights associated with previously presented content items are an inverse function of differences between a current time and times when previously presented content items were presented. The online system determines a feature penalty associated with a feature by combining the weights associated with the previously presented content items having the feature or having an alternative feature similar to the feature. Based on the feature penalties associated with features of the content item, the online system determines the penalty for the content item. In some embodiments, the penalty is a sum of the feature penalties. Weights may be associated with different features and applied to the feature penalties associated with the features when the feature penalties are combined to determine the penalty.

If the content item is associated with a bid amount (e.g., the content item is an ad request), the bid amount is modified based on the bid amount, and the online system includes the content item in a selection process using the modified bid amount. For example, the bid amount is reduced by the penalty. As another example, the bid amount is reduced by a percentage of the penalty, such as a percentage of the penalty that is a ratio of the penalty to the bid amount. In some embodiments, the online system modifies the bid amount based on the penalty if one or more conditions are satisfied. For example, the bid amount of the content item is modified if a ratio of the penalty to the bid amount equals or exceeds a threshold value. Based on the modified bid amount and bid amounts associated with other content items, the selection determines whether to present the content item. For example, if the modified bid amount has at least a threshold position in a ranking of the modified bid amount and additional bid amounts, the content item is selected and communicated to a client device for presentation to the user.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for modifying a bid amount of an advertisement request based on features of the advertisement request and features associated with advertisement content previously presented to a user of an online system, in accordance with an embodiment.

FIG. 4 is a conceptual diagram showing determination of a penalty for an ad request based on features of the ad request and features of ad requests including advertisements previously presented to a user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

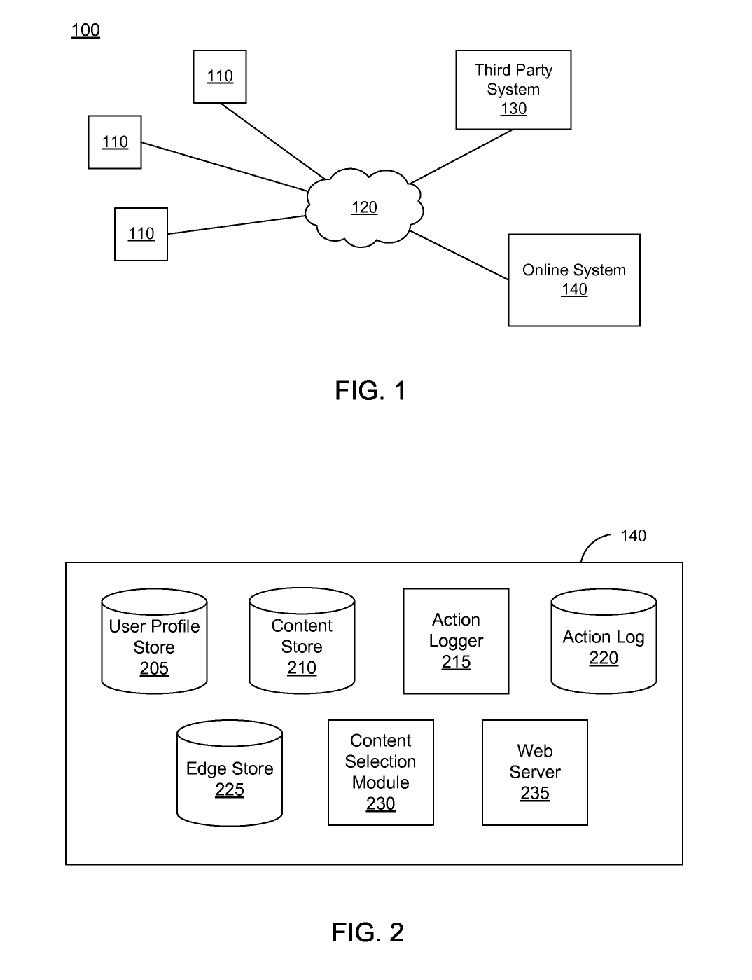

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, information describing a group of users of the online system 140, or information about an application provided by the third party system 130. In some embodiments, a third party system 130 may communicate information directly to the online system 140.

FIG. 2 is a block diagram of an architecture of the online system 140. For example, the online system 140 is a social networking system. The online system 140 shown in FIG. 2 includes a user profile store 205, a content store 210, an action logger 215, an action log 220, an edge store 225, an advertisement (“ad”) request store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 220. In some embodiments, a third party system 130 may indirectly retrieve information from the user profile store 205, subject to one or more privacy settings associated with a user profile by a user, to identify a user profile in the user profile store 205 associated with a user of the third party system 130.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented. For example, the bid amount specifies a monetary amount that the online system 140 receives from the advertiser if advertisement content in an ad request is displayed and the expected value is determined by multiplying the bid amount by a probability of the advertisement content being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The content selection module 235 selects one or more content items for communication to a client device 110 to be presented to a viewing user. Content items eligible for presentation to the viewing user are retrieved from the content store 210, or from another source, by the content selection module 235, which selects one or more of the content items for presentation to the viewing user. A content item eligible for presentation to the viewing user is a content item associated with at least a threshold number of targeting criteria satisfied by characteristics of the viewing user or is a content item that is not associated with targeting criteria. In various embodiments, the content selection module 235 includes content items eligible for presentation to the viewing user in one or more selection processes, which identify a set of content items for presentation to the viewing user. For example, the content selection module 235 determines a measure of relevance of various content items to the user based on characteristics associated with the user by the online system 140 based on the user's affinity for different content items and selects content items for presentation to the user based on the determined measures of relevance. As an example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include ad requests or other content items associated with bid amounts. The content selection module 235 uses the bid amounts associated with various content items when selecting content for presentation to the viewing user. In various embodiments, the content selection module 235 determines an expected value associated with various content items based on their bid amounts and selects content items associated with a maximum expected value or associated with at least a threshold expected value for presentation. An expected value associated with a content item represents an expected amount of compensation to the online system 140 for presenting a content item. For example, the expected value associated with an ad request is a product of the ad request's bid amount and a likelihood of the user interacting with the ad content from the ad request. The content selection module 235 may rank ad requests based on their associated bid amounts and select ad requests having at least a threshold position in the ranking for presentation to the user. In some embodiments, the content selection module 235 may rank both content items and ad requests in a unified ranking based on bid amounts associated with ad request and measures of relevance associated with content items and ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

When selecting content items for presentation to a user, the content selection module 235 accounts for features of content items. To provide the user with diverse content items, the content selection module identifies features of a content item as well as features of content items previously presented to the user within a specified time interval. For example, content items previously presented to the user within the specified time interval from a current time are identified and features of the previously presented content items are identified by the content selection module 235. Features of a content item describe characteristics of the content item or characteristics of content included in the content item. Example features of a content item include: a user associated with the content item, a description of the content included in the content item (e.g., an image identifier, text in the advertisement, an identifier of video included in the advertisement, an identifier of audio data included in the advertisement), a landing page identified by the content item, and one or more topics associated with the content item. If a content item has previously been presented to the user, a feature may identify a type of display unit in which the content item was presented to the user (e.g., if the content item was included in a display unit including multiple content items, if the content item was presented as an individual content item). Additionally, if a content item is an ad request, a feature identifies an advertising campaign including the ad request.

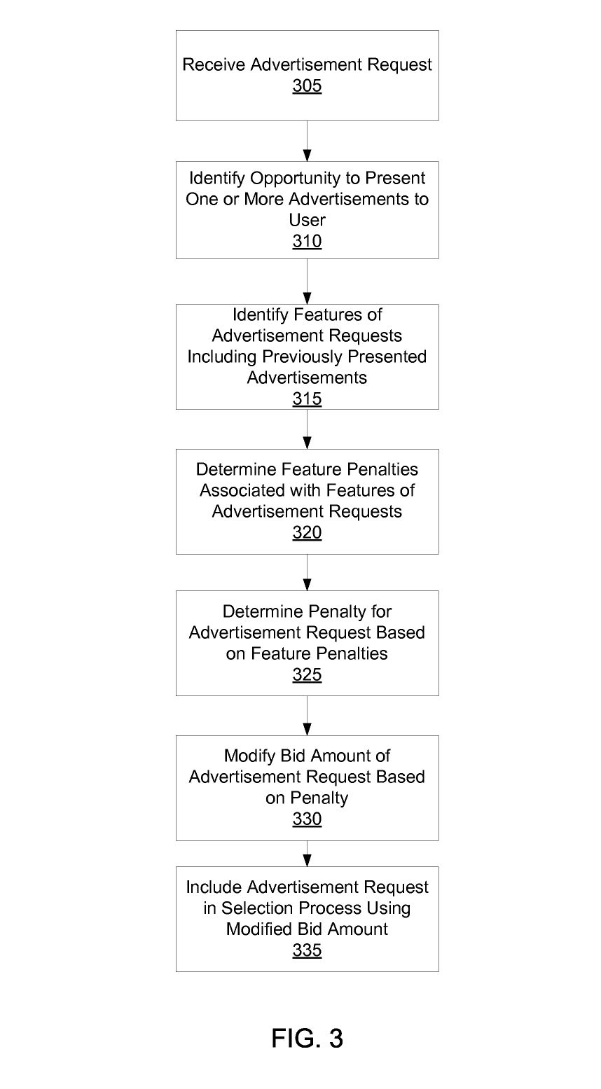

Based on features of a content item and features of content items previously presented to the user, the content selection module 235 determines a penalty for the content item. In one embodiment, the content selection module 235 determines feature penalties associates with various features of the content item. A feature penalty associated with a feature is based on a number of previously presented content items having the feature or having an alternative feature similar to the feature. In some embodiments, the content selection module 235 determines weights associated with various previously presented content items, with a weight associated with a previously presented content item based on a difference between a current time and a time when the previously presented content item was presented. For example, weights associated with previously presented content items are an inverse function of differences between a current time and times when previously presented content items were presented. The content selection module 235 determines a feature penalty associated with a feature by combining the weights associated with the previously presented content items having the feature or having an alternative feature similar to the feature. Based on the feature penalties associated with features of the content item, the content selection module 235 determines the penalty for the content item. In some embodiments, the penalty is a sum of the feature penalties. Weights may be associated with different features and applied to the feature penalties associated with the features when the feature penalties are combined to determine the penalty. Determination of a penalty for a content item is further described below in conjunction with FIG. 3.

If the content item is associated with a bid amount (e.g., the content item is an ad request), the bid amount is modified based on the bid amount, and the content selection module 235 includes the content item in a selection process using the modified bid amount. For example, the bid amount is reduced by the penalty. As another example, the bid amount is reduced by a percentage of the penalty, such as a percentage of the penalty that is a ratio of the penalty to the bid amount. In some embodiments, the content selection module 235 modifies the bid amount based on the penalty if one or more conditions are satisfied. For example, the bid amount of the content item is modified if a ratio of the penalty to the bid amount equals or exceeds a threshold value.

The web server 240 links the online system 140 via the network 120 to the one or more client devices 110, as well as to the one or more third party systems 130. In some embodiments, the web server 240 links the online system 140 directly ton one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 230 may provide application programming interface (API) functionality to send data directly to native client device operating systems, such as IOS®, ANDROID™, WEBOS® or BlackberryOS.

### Modifying Advertisement Request Bid Amounts Based on Advertisement Request Features

FIG. 3 is a flow chart of one embodiment of a method for modifying a bid amount of an advertisement request based on features of the advertisement request and features associated with advertisement content previously presented to a user of an online system 140. In other embodiments, the method may include different and/or additional steps than those described in conjunction with FIG. 3. Additionally, in some embodiments, the method may perform the steps described in conjunction with FIG. 3 in different orders.

The online system 140 receives 305 an advertisement request (“ad request”) that includes an advertisement and a bid amount. As described above in conjunction with FIG. 2, the bid amount specifies an amount of compensation provided by a user associated with the ad request to the online system 140 if the advertisement included in the ad request is presented to online system users or if online system users interact with the presented advertisement. The advertisement included in the ad request comprises one or more features describing characteristics of the advertisement request. For example, a feature identifies an advertising campaign that includes the ad request, while another feature identifies an advertiser associated with the ad request (or another user associated with the ad request). Features of the ad request also describe the advertisement included in the ad request. Example features describing the advertisement included in the ad request include: a description of the content of the advertisement (e.g., an image identifier, text in the advertisement, an identifier of video included in the advertisement, an identifier of audio data included in the advertisement), a landing page included in the advertisement, and one or more topics associated with the advertisement. The online system 140 may extract topics from the advertisement, as described in U.S. patent application Ser. No. 13/167,701, filed Jun. 24, 2011, which is hereby incorporated by reference in its entirety, or a user providing the ad request includes topics associated with the advertisement in the ad request. In some embodiments, the user providing the ad request to the online system 140 specifies a feature associated with the ad request identifying a type of display unit for presenting the advertisement included in the ad request. For example, a feature indicates whether the advertisement included in the ad request is to be presented as an individual advertisement presented in a feed of content items presented to a user or as an advertisement included in a display unit including multiple advertisements.

Additionally, the online system 140 may associate features with an ad request after an advertisement from the ad request has been presented to a user. For example, the online system 140 identifies a type of display unit in which the advertisement was presented to the user. If the advertisement was presented to the user in a display unit in which a user navigates through multiple advertisements by interacting with the display unit, the online system 140 associates a feature with the ad request indicating its advertisement was presented in the display unit with additional advertisements. As another example, the online system 140 associates a feature with the ad request indicating the ad request's advertisement was presented as an individual advertisement within a feed of content items presented to the user if the advertisement was presented in a content feed as an individual advertisement.

The online system 140 identifies 310 an opportunity to present one or more advertisements to a user of the online system 140 and identifies advertisements previously presented to the user. For example, the online system 140 receives a request from a client device 110 for one or more advertisements for presentation to the user or receives a request from the client device 110 for additional content including one or more advertisements for presentation to the user. When the opportunity to present one or more advertisements is identified 310, the online system 140 retrieves information associated with the user identifying advertisements previously presented to the user. For example, the online system 140 retrieves identifiers associated with ad requests including requests previously presented to the user.

One or more features associated with ad requests including advertisements previously presented to the user within a specified time interval (e.g., a day, a week) from a current time are identified 315. Alternatively, one or more features are identified 315 from ad requests including advertisements previously presented to the user within the specified time interval from a time when the opportunity to present one or more advertisements was identified 310. The online system 140 retrieves ad requests including advertisements previously presented to the user within the specified time interval and identifies 315 features associated with the retrieved ad requests. As described above, example features of a retrieved ad request include: an advertising campaign that includes the retrieved ad request, an advertiser associated with the retrieved ad request, a description of the content of the advertisement included in the retrieved ad request (e.g., an image identifier, text in the advertisement, an identifier of video included in the advertisement, an identifier of audio data included in the advertisement), a landing page included in the advertisement included in the retrieved ad request, one or more topics associated with the retrieved ad request, and a type of display unit in which the advertisement included in the retrieved ad request was presented to the user.

Based on the features of the ad requests including advertisements previously presented to the user within the specified time interval, the online system 140 determines 320 feature penalties associated with one or more features of the ad request. In one embodiment, the online system 140 determines 320 feature penalties associated with each feature of the ad request. A feature penalty associated with a feature is determined 320 by comparing the feature to features associated with ad requests including advertisements previously presented to the user within the specified time interval. If the feature associated with the ad request matches a feature of an ad request including an advertisement previously presented to the user within the specified time interval, the feature penalty associated with the feature. In one embodiment, the feature penalty associated with the feature is based on a total number of ad requests including an advertisement previously presented to the user within the specified time interval that include the feature or another feature determined to match the feature. A monetary value may be associated with various features, and the monetary value of a feature is modified based on a number of ad requests including the feature and including advertisements previously presented to the user within the specified time interval. Hence, the feature penalty associated with the feature is proportional to a number of ad requests including advertisements previously presented to the user within the specified time interval having a feature matching the feature.

In some embodiments, the online system 140 maintains information associating alternative features with a feature that are considered to match the feature. Hence, an ad request including an advertisement previously presented to the user within the specified time interval and including an alternative feature is identified by the online system 140 when determining a feature penalty associated with the feature. An advertiser may specify alternative features associated with a feature or the online system 140 may identify alternative features associated with the feature. In some embodiments, ad requests including an advertisement previously presented to the user and including a feature and ad requests including an advertisement previously presented to the user and including an alternative feature are differently weighted by the online system 140 when determining 320 a feature penalty associated with the feature. For example, a weight is applied to ad requests including an advertisement previously presented to the user and including an alternative feature that reduces a contribution of the ad requests including an advertisement previously presented to the user and including an alternative feature to the feature penalty associated with the ad request.

Additionally, weights may be associated with various ad requests including an advertisement previously presented to the user and including an alternative feature based on times when advertisements in the ad requests were presented to the user. In some embodiments, the weights are an inverse function of a difference between a current time (or a time when the opportunity to present one or more advertisements to the user was identified) and a time when an advertisement included in an ad request was previously presented to the user. A feature penalty associated with a feature is determined 320 by combining values associated with the feature that are modified by weights associated with ad requests including the feature (or an alternative matching feature associated with the feature) and including an advertisement presented to the user within the specified time interval. Hence, ad requests including advertisements more recently presented to the user have a greater contribution to a feature penalty associated with a feature of the ad request.

Based on the feature penalties determined 320 for various features of the ad request, the online system 140 determines 325 a penalty for the ad request. For example, the online system combines feature penalties for various features of the ad request to determine 325 the penalty. Hence, the penalty may be a sum of the feature penalties associated with features of the ad request. In some embodiments, weights are associated with various features, and the feature penalties associated with features of the ad request are modified by the weights associated with the features and then combined to determine 325 the penalty for the ad request. Weights associated with various features may be determined by the online system 140 based on information associated with various users (e.g., prior user interactions with advertisements included in ad requests having various features).

The online system 140 modifies 330 the bid amount included in the ad request based on the penalty and includes 335 the ad request in a selection process using the modified bid amount. In one embodiment, the ad request's bid amount is decreased by an amount based on the penalty. For example, the penalty is a monetary amount, and the online system 140 decreases the bid amount of the ad request by the penalty. As another example, the online system 140 decreases the bid amount of the ad request by a percentage of the penalty, which may be determined based on a ratio of the penalty to the bid amount. In some embodiments, the online system 140 determines a ratio between the penalty and the bid amount included in the ad request and modifies 330 the bid amount based on the penalty if the ratio is at least a threshold value. For example, if the ratio of the penalty to the bid amount exceeds the threshold value, the online system 140 decreases the bid amount by the penalty or by a percentage of the penalty that is based on the ratio.

The selection process includes the ad request as well as one or more additional ad requests identified as eligible for presentation to the viewing user and associated with additional bid amounts. In some embodiments, other types of content items (e.g., stories describing actions performed by online system users) are also included in the selection process. Based on the bid amounts associated with ad requests eligible for presentation to the viewing user, the selection process selects one or more ad requests for presentation to the viewing user. For example, the selection process is an auction or other method that ranks ad requests based on their associated bid amounts and selects ad requests having at least a threshold position in the ranking. For example, ad requests having maximum bid amounts or having a threshold position in a ranking of ad requests based on bid amounts are selected. Using the modified bid amount associated with the ad request in the selection process allows the online system 140 to account for prior presentation of advertisements from ad requests having matching or similar features to the ad request to prevent the user from being presented with multiple advertisements having similar features within a time interval. In some embodiments, if the ad request is selected for presentation to the viewing user by the selection process, the online system 140 charges the advertiser associated with ad request the bid amount associated with the ad request without modification by the penalty. This allows the online system 140 to enhance user experience by reducing the likelihood of the online system 140 presenting the user with repetitive advertisement content without impairing revenue to the online system 140 from advertisers. Alternatively, the online system 140 may charge the advertiser associated with the ad request the modified bid amount.

While FIG. 3 describes modifying a bid amount of an advertisement request based on features of the advertisement request and features associated with advertisement content previously presented to a user of an online system 140, the method described in conjunction with FIG. 3 may be applied to modifying a bid amount of an advertisement request associated with advertisements within other content provided via the online system 140. In one embodiment, the online system 140 allows its users to exchange messages with each other and presents a user with a thread including multiple messages exchanged between users. For example, the thread includes messages exchanged between the user and an additional user. Alternatively, the thread includes messages between the user and multiple additional users. An application associated with the online system 140 may execute on client devices 110 associated with various users; the application communicates messages received from a user to the online system 140 for presentation to one or more additional users via a thread and presents messages received from one or more other users to the user via the online system 140 to the user via a thread. In some embodiments, the online system 140 may include one or more advertisements in a thread presented to a user along with messages for presentation to the user and enforce one or more advertising policies regulating presentation insertion or position of advertisements within the thread of messages. As described above in conjunction with FIG. 3, the online system 140 may determine a bid amount of an advertisement request based on features of the advertisement request and features associated with advertisement content previously presented to a user of an online system 140, and select one or more advertisements to include in a thread of messages presented to the user via the online system 140 based on the modified bid amounts associated with the advertisements requests.

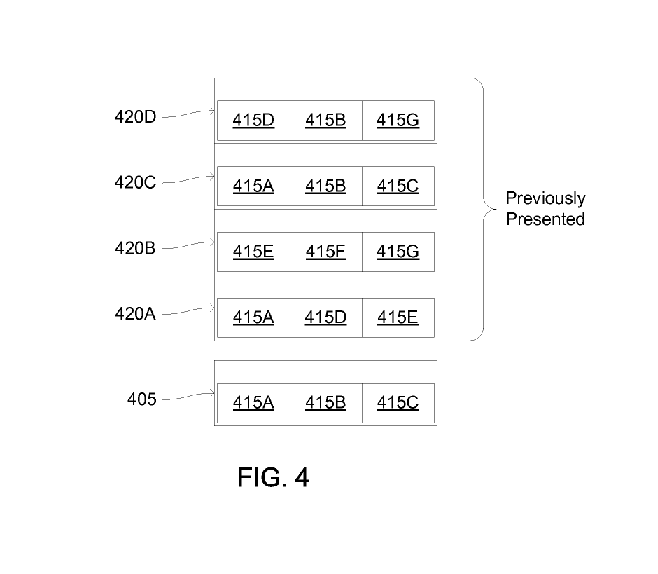

FIG. 4 is a conceptual diagram showing determination of a penalty for an ad request based on features of the ad request and features of ad requests including advertisements previously presented to a user. While FIG. 4 shows an example including ad requests, the method described herein may be applied to other types of content items. In the example of FIG. 4, ad request 405 is received from an advertiser and an opportunity to present one or more advertisements to a user has been identified by the online system 140.

The online system 140 identifies ad requests 420A, 420B, 420C, 420D, each of which include advertisements previously presented to the user within a specified time interval from a current time. In FIG. 4, ad request 405 includes features 415A, 415B, 415C, so the online system 140 determines feature penalties associated with each of feature 415A, 415B, 415C based on features associated with ad requests 420A, 420B, 420C, 420D. Ad request 420A includes features 415A, 415D, 415E, with feature 415A matching feature 415A of ad request 405. Similarly, ad request 420C, like ad request 405, includes features 415A, 415B, 415C. Ad request 420D has features 415B, 415C in common with ad request 405, while ad request 420D also includes feature 415D. Additionally, ad request 420B includes features 415E, 415F, 415G, which do not match a feature of ad request 405. Accordingly, the online system 140 determines a feature score for feature 415A based on the two ad requests (ad requests 420A, 420C) including feature 415A, determines a feature score for feature 415B based on the two ad requests (ad requests 420C, 420D) including feature 415B, and determines a feature score for feature 415C based on the single ad request (ad request 420C) including feature 415C. If ad request 420D includes an advertisement presented less recently to the user than an advertisement included in ad request 420C, the online system 140 may associate different weights with ad request 420D and ad request 420C when determining a feature penalty for feature 415B so a contribution of ad request 420D to the feature penalty for feature 415B is less than the contribution of ad request 420C. For example, a value of $0.40 is associated with feature 415B, and weights of 0.05 and 0.10 are associated with ad request 420D and ad request 420C, respectively; in this example, the feature penalty associated with feature 415B is ($0.40)(0.05)+($0.404)(0.1), or $0.06. By combining the feature penalties for features 415A, 415B, and 415C, the online system 140 determines a penalty for application to a bid amount associated with ad request 405, as described above in conjunction with FIG. 3.

### SUMMARY

The foregoing description of embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of embodiments is intended to be illustrative, but not limiting, of the scope of the patent rights, which is set forth in the following claims.

What is claimed is:

1. A method comprising:
receiving, at an online system, information describing an advertisement request from an advertiser, the advertisement request including an advertisement having one or more features and a bid amount;
identifying an opportunity to present one or more advertisements to a user of the online system;
identifying features of one or more advertisements previously presented to the user of the online system within a specified time interval from a current time;
determining feature penalties associated with the one or more features of the advertisement request, a feature penalty associated with a feature based at least in part on a number of advertisements previously presented to the user within the specified time interval having the feature;
determining a penalty based at least in part on the determined feature penalties;
modifying the bid amount included in the advertisement request based on the penalty; and
including the advertisement request and the modified bid amount in a selection process performed by the online system.

2. The method of claim 1, wherein determining feature penalties associated with the one or more features of the advertisement request comprises:
associating weights with each advertisement previously presented to the user having the feature, the weights based at least in part on a time difference between the current time and a time when an advertisement previously presented to the user having the feature was presented to the user;
determining the feature penalty for the feature based at least in part on the weights.

3. The method of claim 2, wherein a weight is an inverse function of the time difference between the current time and the time when the advertisement previously presented to the user having the feature was presented to the user.

4. The method of claim 2, wherein determining the feature penalty for the feature based at least in part on the weights comprises:
determining the feature penalty for the feature as a sum of the weights.

5. The method of claim 1, wherein modifying the bid amount included in the ad request based on the penalty comprises:
reducing the bid amount by a value based at least in part on the penalty.

6. The method of claim 1, wherein modifying the bid amount included in the ad request based on the penalty comprises:
determining a ratio of the penalty to the bid amount; and
modifying the bid amount based on the penalty if the ratio is at least a threshold value.

7. The method of claim 1, modifying the bid amount included in the ad request based on the penalty comprises
applying a percentage of the penalty to the advertisement, the percentage based at least in part on a ratio of the penalty to the bid amount.

8. The method of claim 1, wherein a feature associated with the advertisement request is selected from a group consisting of: an advertising campaign associated with the advertisement request, an object associated with the advertisement request, an advertiser associated with the advertisement request, content included in the advertisement of the advertisement request, a landing page associated with the advertisement of the advertisement request, one or more topics associated with the advertisement of the advertisement request, and any combination thereof.

9. The method of claim 1, wherein a feature associated with the advertisement request comprises a type of display unit in which the advertisement of the advertisement request is to be presented.

10. The method of claim 1, wherein a feature of an advertisement previously presented to the user of the online system within the specified time interval from the current time is selected from a group consisting of: an advertising campaign associated with the advertisement request, an object associated with the advertisement request, an advertiser associated with the advertisement request, content included in the advertisement of the advertisement request, a landing page associated with the advertisement of the advertisement request, one or more topics associated with the advertisement of the advertisement request, and any combination thereof.

11. A method comprising:
receiving, at an online system, information describing an advertisement request from an advertiser, the advertisement request including an advertisement having one or more features and a bid amount;
identifying an opportunity to present one or more advertisements to a user of the online system;
identifying features of one or more advertisements previously presented to the user of the online system within a specified time interval from a current time;
determining a penalty for the advertisement request based at least in part on the one or more features of the advertisement request and the features of the one or more advertisements previously presented to the user of the online system within the specified time interval from the current time;
modifying the bid amount included in the advertisement request based on the penalty; and
including the advertisement request and the modified bid amount in a selection process performed by the online system.

12. The method of claim 11, wherein determining the penalty for the advertisement request based at least in part on the one or more features of the advertisement request and the features of the one or more advertisements previously presented to the user of the online system within the specified time interval from the current time comprises:
determining feature penalties associated with the one or more features of the advertisement request, a feature penalty associated with a feature based at least in part on a number of advertisements previously presented to the user within the specified time interval having the feature; and
determining the penalty based at least in part on the determined feature penalties.

13. The method of claim 12, wherein determining feature penalties associated with the one or more features of the advertisement request comprises:
associating weights with each advertisement previously presented to the user having the feature, the weights based at least in part on a time difference between the current time and a time when an advertisement previously presented to the user having the feature was presented to the user;
determining the feature penalty for the feature based at least in part on the weights.

14. The method of claim 13, wherein a weight is an inverse function of the time difference between the current time and the time when the advertisement previously presented to the user having the feature was presented to the user.

15. The method of claim 13, wherein determining the feature penalty for the feature based at least in part on the weights comprises:
determining the feature penalty for the feature as a sum of the weights.

16. The method of claim 11, wherein modifying the bid amount included in the ad request based on the penalty comprises:
reducing the bid amount by a value based at least in part on the penalty.

17. A computer program product comprising a computer readable storage medium having instructions encoded thereon that, when executed by a processor, cause the processor to:
receive, at an online system, information describing an advertisement request from an advertiser, the advertisement request including an advertisement having one or more features and a bid amount;
identify an opportunity to present one or more advertisements to a user of the online system;
identify features of one or more advertisements previously presented to the user of the online system within a specified time interval from a current time;
determine a penalty for the advertisement request based at least in part on the one or more features of the advertisement request and the features of the one or more advertisements previously presented to the user of the online system within the specified time interval from the current time;
modify the bid amount included in the advertisement request based on the penalty; and
include the advertisement request and the modified bid amount in a selection process performed by the online system.

18. The computer program product of claim 17, wherein determine the penalty for the advertisement request based at least in part on the one or more features of the advertisement request and the features of the one or more advertisements previously presented to the user of the online system within the specified time interval from the current time comprises:
determine feature penalties associated with the one or more features of the advertisement request, a feature penalty associated with a feature based at least in part on a number of advertisements previously presented to the user within the specified time interval having the feature; and
determine the penalty based at least in part on the determined feature penalties.

19. The computer program product of claim 18, wherein determine feature penalties associated with the one or more features of the advertisement request comprises:
associate weights with each advertisement previously presented to the user having the feature, the weights based at least in part on a time difference between the current time and a time when an advertisement previously presented to the user having the feature was presented to the user; and
determine the feature penalty for the feature based at least in part on the weights.

20. The computer program product of claim 17, wherein a feature associated with the advertisement request is selected from a group consisting of: an advertising campaign associated with the advertisement request, an object associated with the advertisement request, an advertiser associated with the advertisement request, content included in the advertisement of the advertisement request, a landing page associated with the advertisement of the advertisement request, one or more topics associated with the advertisement of the advertisement request, and any combination thereof.
